(19) United States
(12) Patent Application Publication
(10) Pub. No.: US 2025/0276416 A1
(43) Pub. Date: Sep. 4, 2025

(54) CONTROL DEVICE FOR MACHINE TOOL

(71) Applicant: FANUC CORPORATION, Minamitsuru-gun, Yamanashi (JP)

(72) Inventors: Yuutarou HORIKAWA, Yamanashi (JP); Masashi YASUDA, Yamanashi (JP)

(73) Assignee: FANUC CORPORATION, Minamitsuru-gun, Yamanashi (JP)

(21) Appl. No.: 18/858,152

(22) PCT Filed: May 13, 2022
(86) PCT No.: PCT/JP2022/020243

§ 371 Date: Oct. 18, 2024

(51) Int. Cl. B23Q 15/013; G05B 19/4093

(52) U.S. Cl. CPC B23Q 15/013; G05B 19/4093; G05B 2219/37434

(57) ABSTRACT

Provided is a technology with which a chip length can be calculated, and with which a machining condition and an oscillation condition can be set easily while checking the calculated chip length. A control device 1 of a machine tool which performs machining while causing a cutting tool and a workpiece to oscillate relative to one another comprises: a condition acquiring unit 12 for acquiring a machining condition and an oscillation condition; a chip length calculating unit 13 for calculating a chip length on the basis of the machining condition and the oscillation condition acquired by the condition acquiring unit 12; and a chip length outputting unit 14 for outputting the chip length calculated by the chip length calculating unit 13.

### TECHNICAL FIELD

The present disclosure relates to a control device for machine tools.

### BACKGROUND ART

Conventionally, oscillation cutting is known in which a workpiece is machined by cutting while a cutting tool and the workpiece are relatively oscillated in order to prevent chips continuously generated during cutting from becoming entangled with the workpiece or the cutting tool, which can cause defects or machine failures. In the oscillation cutting, the oscillation frequency and the oscillation amplitude are adjusted, whereby the tool route as the path of the cutting tool is set to partially overlap the previous tool route. As a result, an air cut occurs, where the cutting edge of the cutting tool moves away from the surface of the workpiece, whereby the chips are shredded.

However, even if the chips are shredded, if the chip length is too long, the chips may still entangle with the workpiece or the cutting tool. Excessive oscillation of the cutting tool or workpiece to shorten the chip length may increase the machine load, potentially leading to machine failure.

For example, a technique considering the chip length has been proposed to determine the number of vibrations (oscillations), based on the chip length and workpiece diameter which have been set (for example, see Patent Document 1). According to this technique, the number of vibrations can be automatically determined based on the desired set chip length and workpiece diameter which have been set.

### CITATION LIST

### Patent Document

Patent Document 1: Japanese Patent No. 6744815

### DISCLOSURE OF THE INVENTION

### Problems to be Solved by the Invention

However, the technique disclosed in Patent Document 1 simply determines the desired chip length from the number of oscillations. Yet, since the chip length depends on the machining conditions and oscillation conditions, it has been difficult to set the machining conditions and oscillation conditions while considering the chip length. Therefore, a technique capable of calculating the chip length and easily setting the machining conditions and oscillation conditions while verifying the calculated chip length is desired.

The present disclosure has been made in view of the above problems, and an object thereof is to provide a technique capable of calculating the chip length and easily setting the machining conditions and oscillation conditions while verifying the calculated chip length.

### Means for Solving the Problems

The present disclosure provides a control device for a machine tool that machines a workpiece while relatively oscillating the cutting tool and the workpiece. The control device includes: a condition acquisition unit that acquires machining conditions and oscillation conditions; a chip length calculation unit that calculates a chip length, based on the machining conditions and the oscillation conditions acquired by the condition acquisition unit; and a chip length output unit that outputs the chip length calculated by the chip length calculation unit.

### Effects of the Invention

According to the present disclosure, it is possible to provide a technique capable of calculating a chip length and easily setting machining conditions and oscillation conditions while verifying the calculated chip length.

### BRIEF DESCRIPTION OF THE DRAWINGS

FIG. 1 is a diagram illustrating oscillation cutting;

FIG. 2 is a functional block diagram of a machine tool control device according to the first embodiment;

FIG. 3 is a diagram illustrating a chip length confirmation screen where machining conditions and oscillation conditions have been input;

FIG. 4 is a diagram illustrating a cutting path;

FIG. 5 is a diagram illustrating a chip length confirmation screen displaying the calculated chip length;

FIG. 6 is a functional block diagram of a machine tool control device according to the second embodiment;

FIG. 7 is a diagram illustrating the first example of a chip length correction table;

FIG. 8 is a diagram illustrating the first example of the chip length correction table;

FIG. 9 is a diagram illustrating a chip length confirmation screen displaying the calculated chip length;

FIG. 10 is a diagram illustrating a chip length confirmation screen displaying the chip length corrected based on the chip length correction coefficient;

FIG. 11 is a diagram illustrating the second example of the chip length correction table;

FIG. 12 is a diagram illustrating the second example of the chip length correction table;

FIG. 13 is a diagram illustrating a chip length confirmation screen displaying the calculated chip length;

FIG. 14 is a diagram illustrating a chip length confirmation screen displaying the chip length corrected for each type of workpiece;

FIG. 15 is a functional block diagram of a machine tool control device according to the third embodiment;

FIG. 16 is a diagram illustrating the attenuation rate of the actual measured value against the command value of the oscillation amplitude;

FIG. 17 is a diagram illustrating a chip length confirmation screen where the attenuation rate of the oscillation amplitude has been input; and

FIG. 18 is a diagram illustrating a chip length confirmation screen displaying the chip length corrected based on the attenuation rate of the oscillation amplitude.

### PREFERRED MODE FOR CARRYING OUT THE INVENTION

Hereinafter, the embodiments of the present disclosure will be described in detail with reference to the drawings. In the descriptions of the second and subsequent embodiments, components common to the first embodiment are denoted by the same reference numerals, and their descriptions are omitted as appropriate.

### First Embodiment

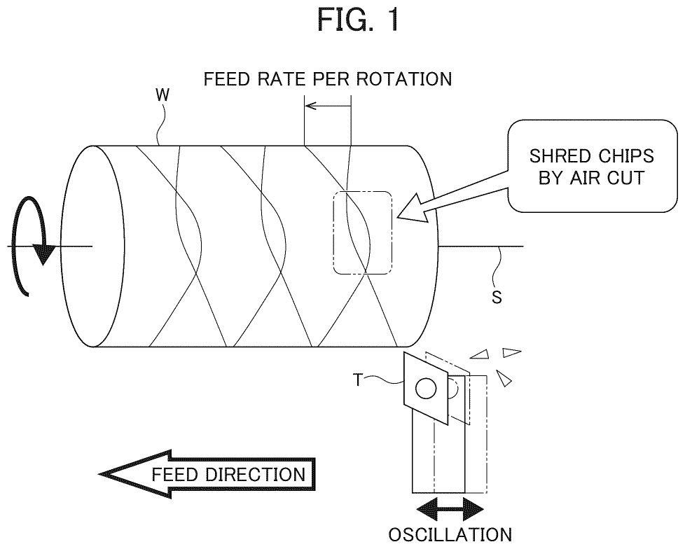

The machine tool control device according to the first embodiment performs oscillation cutting, in which a workpiece is machined by cutting while the cutting tool and the workpiece are relatively oscillated. FIG. 1 is a diagram illustrating oscillation cutting. In the example of oscillation cutting illustrated in FIG. 1, at least one spindle S that relatively rotates the cutting tool T and the workpiece W, and at least one feed shaft (not illustrated) that relatively moves the cutting tool T relative to the workpiece W, are operated to relatively rotate the cutting tool T and the workpiece W, while oscillating the cutting tool T and the workpiece W in the feed direction during cutting machining. In this case, the tool route as the path of the cutting tool T is set such that the current route partially overlaps the previous route. Since the current route partially includes the machined portion in the previous route, an air cut occurs such that the cutting edge of the cutting tool T moves away from the surface of the workpiece W, thereby shredding the chips.

In the oscillation cutting executed in the present embodiment, the shape of the workpiece is not limited. That is, the present embodiment can be applied to the cases where a plurality of feed shafts (Z-axis and X-axis) are required since the workpiece includes taper portions or arc portions on the machining surface, or the cases where one specific feed shaft (Z-axis) is sufficient since the workpiece is columnar or cylindrical.

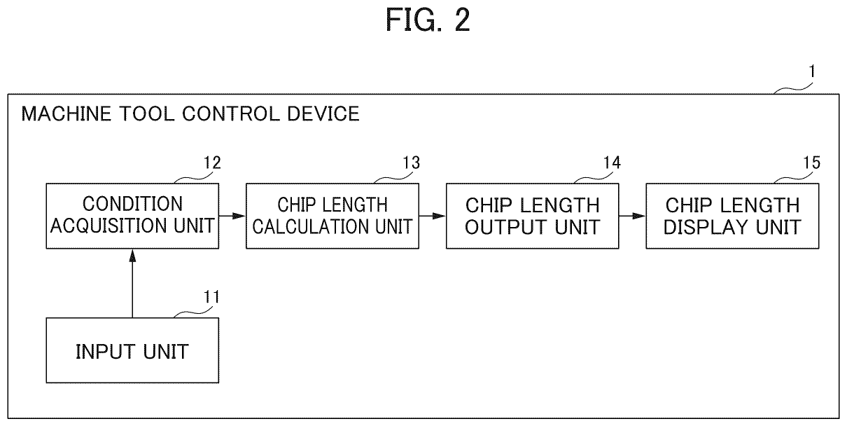

FIG. 2 is a functional block diagram of a machine tool control device 1 according to the first embodiment. As illustrated in FIG. 2, the machine tool control device 1 according to the first embodiment includes an input unit 11, a condition acquisition unit 12, a chip length calculation unit 13, a chip length output unit 14, and a chip length display unit 15. The machine tool control device 1 is composed of a computer that includes memory such as ROM (read-only memory) and RAM (random access memory), a CPU (control processing unit), and a communication control unit, which are connected to each other via a bus. The functions and operations of each functional unit are achieved by the CPU, memory, and control programs stored in the memory working together in the computer.

The machine tool control device 1 may be composed of a CNC (Computer Numerical Controller) and may be connected to higher-level computers such as a CNC or a PLC (Programmable Logic Controller) (not illustrated). The higher-level computer inputs machining conditions such as rotation speed and feed rate, and oscillation conditions such as oscillation amplitude and oscillation frequency to the machine tool control device 1.

The input unit 11 inputs information on machining conditions and oscillation conditions in response to input operations by an operator using input means (not illustrated), such as a keyboard or a touch panel. The information on machining conditions and oscillation conditions input by the input unit 11 is output to the condition acquisition unit 12, which will be described later.

The condition acquisition unit 12 acquires the machining conditions and oscillation conditions input by the input unit 11. The condition acquisition unit 12 outputs the acquired machining conditions and oscillation conditions to the chip length calculation unit 13, which will be described later.

Here, the machining conditions include at least information on the machining diameter (mm) and, for example, information on the rotation number S (1/min) of the spindle, the feed amount per revolution F (mm/rev), the feed rate of the cutting tool (mm/min), the workpiece diameter (mm), the radius (R) (mm) of the cutting edge, and the clearance angle) (° of the cutting tool.

The oscillation conditions include information on the number of oscillations per relative revolution of the cutting tool and workpiece, and information on the oscillation amplitude relative to the feed amount per relative revolution of the cutting tool and workpiece. Information on the number of oscillations per relative revolution of the cutting tool and the workpiece includes an oscillation frequency multiplying factor I (times), which indicates the oscillation frequency per revolution of the spindle. Information on the oscillation amplitude relative to the feed amount per relative revolution of the cutting tool and the workpiece includes an oscillation amplitude multiplying factor K (times), which indicates the magnitude of the oscillation amplitude relative to the feed amount per revolution of the spindle. The oscillation frequency multiplying factor I (times) may be specified directly or may be calculated from the oscillation frequency (Hz) and the rotation number S (1/min) of the spindle after specifying the oscillation frequency (Hz). Similarly, the oscillation amplitude multiplying factor K (times) may be specified directly or may be calculated from the oscillation amplitude (mm) and the feed amount per revolution F (mm/rev) after specifying the oscillation amplitude (mm).

The chip length calculation unit 13 calculates the chip length, based on the machining conditions and the oscillation conditions acquired by the condition acquisition unit 12. The specific method of calculating the chip length will be described in detail later.

The chip length output unit 14 externally outputs the chip length calculated by the chip length calculation unit 13. In the present embodiment, the chip length output unit 14 outputs the calculated chip length to the chip length display unit 15, which will be described later.

The chip length display unit 15 displays the chip length output by the chip length output unit 14. Specifically, the chip length display unit 15 displays the chip length calculated by the chip length calculation unit 13 on a chip length confirmation screen, which will be described in detail later.

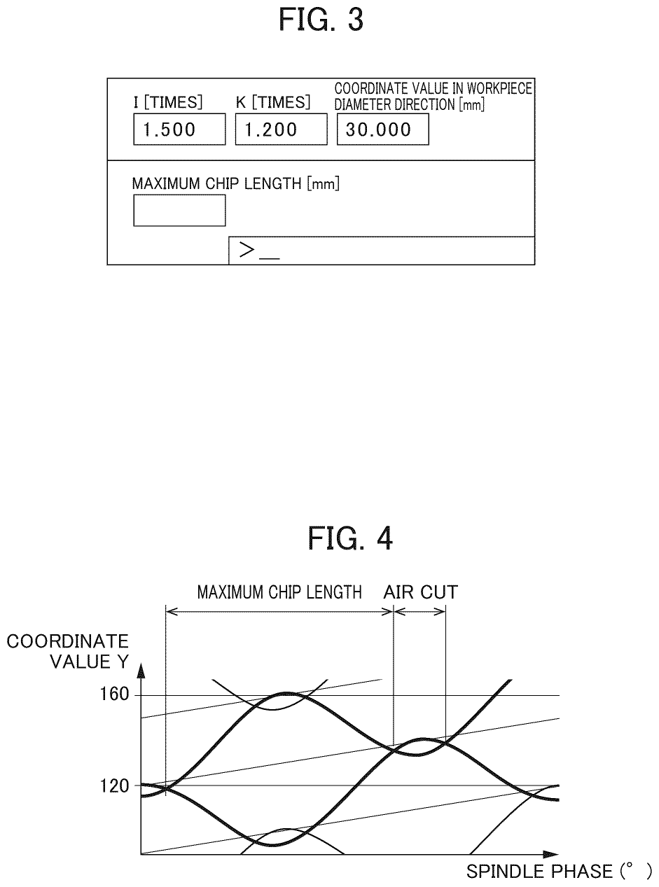

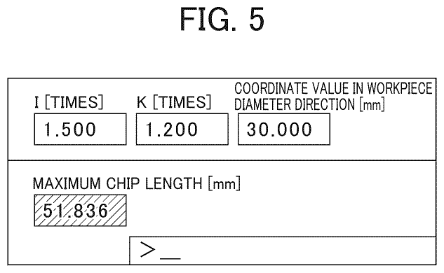

Next, the method of calculating the chip length by the chip length calculation unit 13 will be described in detail with reference to FIGS. 3 to 5. FIG. 3 is a diagram illustrating a chip length confirmation screen where machining conditions and oscillation conditions have been input. FIG. 4 is a diagram illustrating a cutting path. FIG. 5 is a diagram illustrating a chip length confirmation screen displaying the calculated chip length.

As illustrated in FIG. 3, first, the operator inputs the machining conditions and oscillation conditions by operating the input means of the input unit 11 using the chip length confirmation screen of the chip length display unit 15. For example, as illustrated in the example in FIG. 3, the operator inputs the machining conditions including the coordinate value in the workpiece diameter direction (also referred to as coordinate value X) that is the information on the machining diameter, and the oscillation conditions including the oscillation frequency multiplying factor I and the oscillation amplitude multiplying factor K.

Then, the condition acquisition unit 12 acquires the input machining conditions and the oscillation conditions, and the chip length calculation unit 13 automatically calculates the chip length, based on the machining conditions and the oscillation conditions thus acquired. Specifically, the chip length calculation unit 13 calculates the coordinate value Y (mm) in the feed direction of the cutting path using the following Formula 1, and searches for the portion with the maximum phase difference between the intersection points of the cutting paths (previous cutting path and current cutting path).

$$\begin{matrix}Formula 1 & \\ Y = \frac{fS}{60} t + \frac{Kf}{2} \{ cos ( 2 π \frac{SI}{60} t ) - 1 \} & FORMULA ( 1 )\end{matrix}$$

In Formula 1, Y represents the coordinate value in the feed direction (mm), f represents the feed amount per revolution (mm/rev) of the spindle, S represents the rotation number (1/min) of the spindle, I represents the oscillation frequency multiplying factor (times), K represents the oscillation amplitude multiplying factor (times), and t represents the time (sec).

Here, as illustrated in FIG. 4, the intersection of the previous and current cutting paths is the start or end point of an air cut. That is, the portion with the maximum phase difference between the intersections of the previous and current cutting paths represents the cutting section where the chip length becomes maximum. Therefore, in the present embodiment, the phase difference in the cutting section for the maximum chip length is obtained by Formula 1, and the maximum chip length obtained by multiplying the phase difference in the cutting section for the maximum chip length by the workpiece radius (mm) is calculated as the chip length (mm), as in Formula 2. Hereinafter, the present specification will describe the maximum chip length and the chip length as synonymous.

$$\begin{matrix}Formula 2 & \\ Chip length = ( phase difference ( ° ) of cutting section for maximum \\ chip length / 360 ( ° ) ) \times workpiece radius \times 2 π & FORMULA ( 2 )\end{matrix}$$

As is clear from the above-described method of calculating the chip length, the chip length calculated by the chip length calculation unit 13 of the present embodiment excludes the air cut section. In contrast, the conventionally known chip length calculation includes the air cut section, in which the chip length is calculated by: chip length (mm)=2πr/I, where the workpiece radius (mm) is r, and the oscillation frequency multiplying factor (times) is I. Therefore, compared to the conventional method, the chip length calculation unit 13 of the present embodiment can calculate a more accurate chip length.

As illustrated in FIG. 5, the chip length calculated by the chip length calculation unit 13 is automatically displayed on the chip length confirmation screen. This allows the operator to set machining conditions and oscillation conditions while verifying the chip length that is calculated more accurately than conventional, allowing for easily setting the machining conditions and oscillation conditions.

The machine tool control device 1 according to the first embodiment can achieve the following effects.

The machine tool control device 1 according to the present embodiment includes the condition acquisition unit 12 that acquires machining conditions and oscillation conditions, the chip length calculation unit 13 that calculates the chip length, based on the machining conditions and oscillation conditions, and the chip length output unit 14 that outputs the calculated chip length. Therefore, while the chip length depends upon the machining conditions and oscillation conditions, and it was conventionally difficult to set machining conditions and oscillation conditions considering the chip length, the present embodiment allows for calculating the chip length, based on the machining conditions and oscillation conditions, and allows the operator to easily set the machining conditions and oscillation conditions while verifying the chip length that has been calculated and externally output.

The machine tool control device 1 according to the present embodiment further includes the chip length display unit 15 that displays the chip length output by the chip length output unit 14. This allows the operator to more easily set machining conditions and oscillation conditions while verifying the chip length displayed on the display screen of the chip length display unit 15.

The machine tool control device 1 according to the present embodiment acquires the machining conditions including the information on the machining diameter, and the oscillation conditions including the information on the number of oscillations per relative revolution of the cutting tool and the workpiece, and information on the oscillation amplitude relative to the feed amount per relative revolution of the cutting tool and the workpiece, and calculates the chip length, based on the machining conditions and the oscillation conditions. Thus, although the chip length depends on the oscillation amplitude that significantly affects the occurrence of air cuts, conventional methods did not take oscillation amplitude into account. However, according to the present embodiment, the oscillation amplitude is included in the calculation conditions, allowing for calculating a more accurate chip length excluding the air cut section.

### Second Embodiment

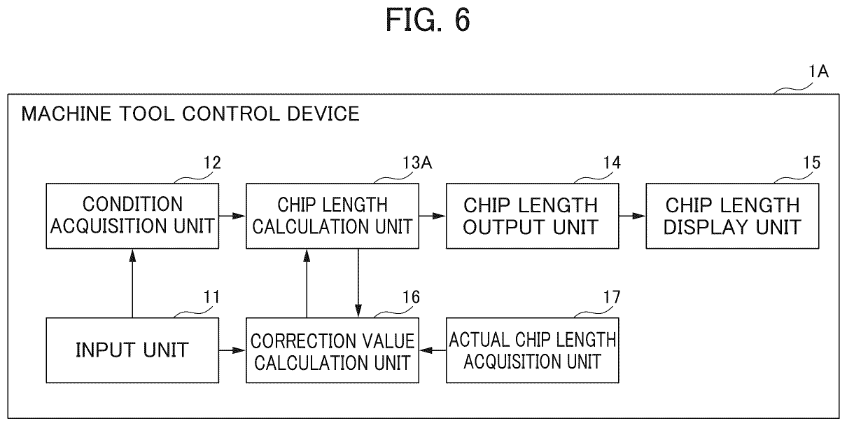

FIG. 6 is a functional block diagram of a machine tool control device 1A according to the second embodiment. As illustrated in FIG. 6, the machine tool control device 1A according to the second embodiment further includes a correction value calculation unit 16 and an actual chip length acquisition unit 17, which differs from the machine tool control device 1 according to the first embodiment. Additionally, the chip length calculation unit 13A also performs chip length correction, which differs from the chip length calculation unit 13 of the first embodiment. Other configurations are common to the first embodiment.

The actual chip length acquisition unit 17 acquires the actual chip length by measuring the length of the chips obtained by actually performing oscillation cutting machining. The acquired actual chip length is output to the correction value calculation unit 16, which will be described later.

The correction value calculation unit 16 calculates the correction value that is used for correcting the chip length. Specifically, the correction value calculation unit 16 calculates the correction value, based on the theoretical chip length calculated by the chip length calculation unit 13A and the actual chip length acquired by the actual chip length acquisition unit 17. For example, the correction value calculation unit 16 calculates the correction coefficient or correction amount, based on the deviation multiplying factor or difference between the theoretical chip length and the actual chip length obtained by actually performing oscillation cutting machining under the machining conditions and oscillation conditions used for calculation. The calculated correction value is output to the chip length calculation unit 13A, which will be described later.

The correction value calculation unit 16 preferably calculates correction values for each machining condition. Specifically, the correction value calculation unit 16 preferably calculates correction values for each machining condition, including at least one of the material of the cutting edge of the cutting tool, the shape of the cutting edge of the cutting tool, the material of the workpiece, the cutting speed, the cutting depth, or the cutting angle.

The chip length calculation unit 13A calculates the chip length, based on the machining conditions and oscillation conditions acquired by the condition acquisition unit 12, using the same calculation method as the one used in the chip length calculation unit 13 of the first embodiment. The chip length calculation unit 13A corrects the calculated theoretical chip length using the correction value calculated by the correction value calculation unit 16, which differs from the chip length calculation unit 13 of the first embodiment.

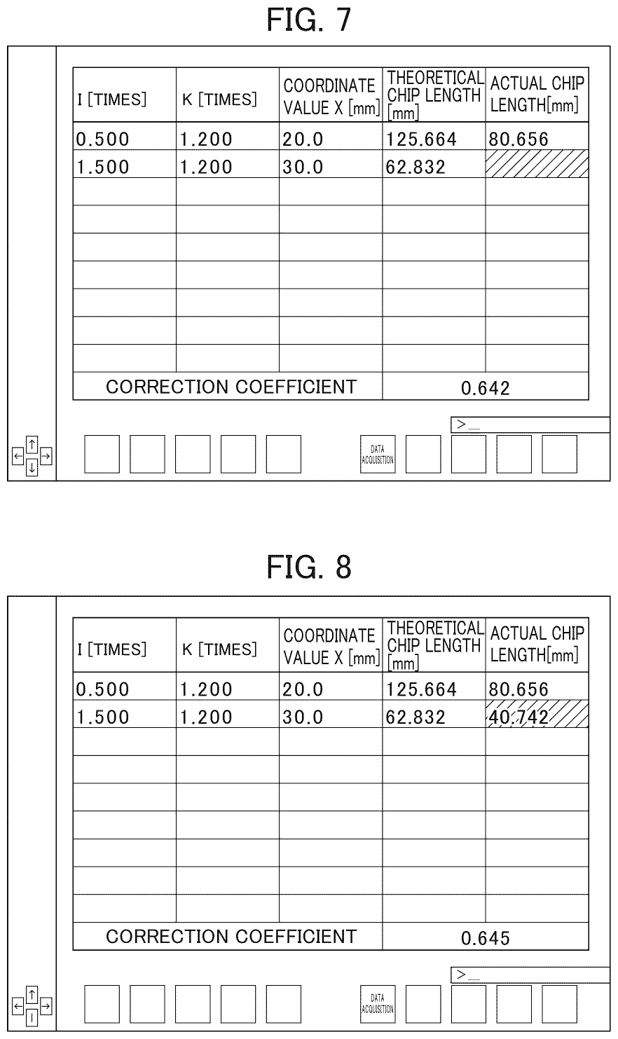

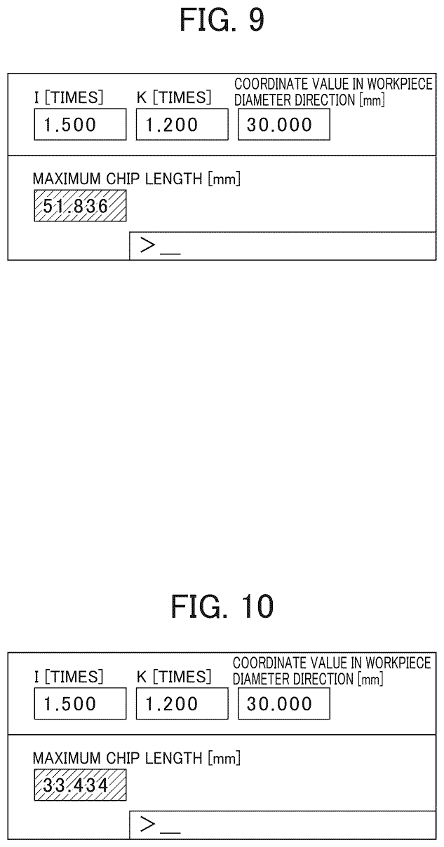

Next, a first example of the chip length correction method by the chip length calculation unit 13A will be described in detail with reference to FIGS. 7 to 10. FIGS. 7 and 8 are diagrams illustrating the first example of the chip length correction table. FIG. 9 is a diagram illustrating a chip length confirmation screen displaying the calculated chip length. FIG. 10 is a diagram illustrating a chip length confirmation screen displaying the chip length corrected based on the correction coefficient.

First, similarly to the first embodiment described above, the operator inputs the machining conditions including the coordinate value X in the workpiece diameter direction that is information on the machining diameter, and the oscillation conditions including the oscillation frequency multiplying factor I and the oscillation amplitude multiplying factor K. Then, as illustrated in FIG. 9, the theoretical chip length automatically calculated by the chip length calculation unit 13A is displayed as the chip length on the chip length confirmation screen. The operator operates the machine tool control device 1A before and after the above input operation, actually performs the oscillation cutting machining using the machining conditions and oscillation conditions used for calculating the theoretical chip length, and measures the length of the obtained chips.

Next, the operator operates the input means of the input unit 11 to open the chip length correction table as illustrated in FIG. 7 to correct the calculated theoretical chip length. As illustrated in FIG. 7, the chip length correction table automatically displays the coordinate value X in the workpiece diameter direction, the oscillation frequency multiplying factor I, and the oscillation amplitude multiplying factor K, which are input on the chip length confirmation screen, as well as the calculated theoretical chip length.

Then, the operator operates the input means of the input unit 11 to input the actual chip length measured. Based on the deviation multiplying factor between the theoretical chip length and the actual chip length, the correction value calculation unit 16 automatically calculates the correction coefficient. The calculated correction coefficient is automatically displayed in the chip length correction table. As illustrated in FIG. 10, the chip length displayed on the chip length confirmation screen is changed to the value of the chip length corrected using the correction coefficient.

As illustrated in FIGS. 7 and 8, if there are a plurality of combinations of machining conditions and oscillation conditions to be input, and there are a plurality of combinations of theoretical chip lengths and actual chip lengths for each combination of conditions, the correction value calculation unit 16 preferably automatically calculates the correction coefficient, based on the arithmetic average of the deviation multiplying factors between the theoretical chip length calculated for each combination and the actual chip length. Other data analysis methods such as geometric mean, harmonic mean, median, and mode value may also be used for deriving the correction coefficient from the deviation multiplying factor.

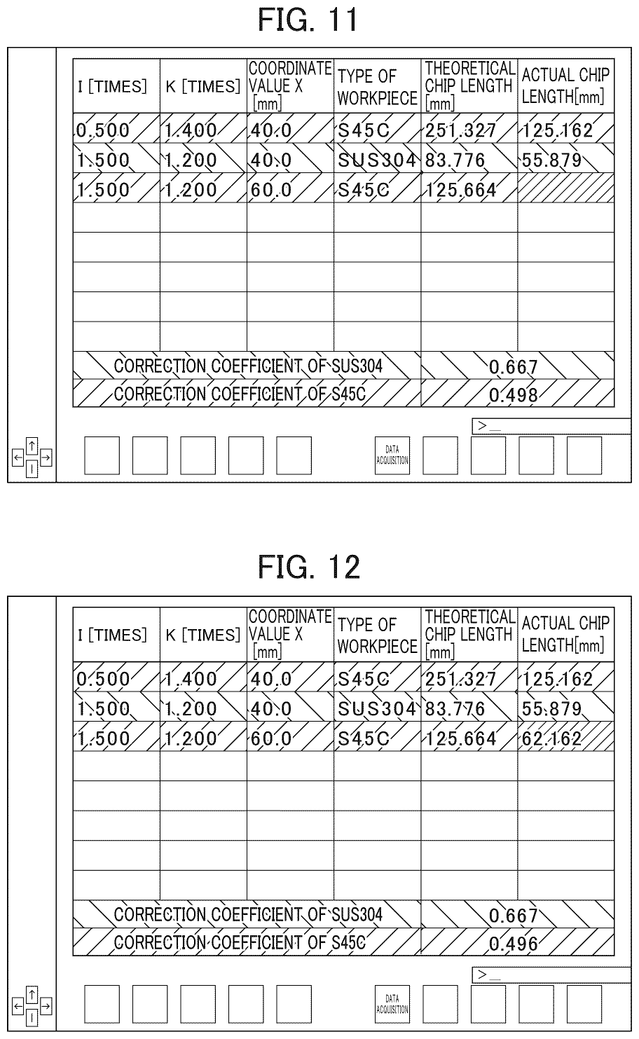

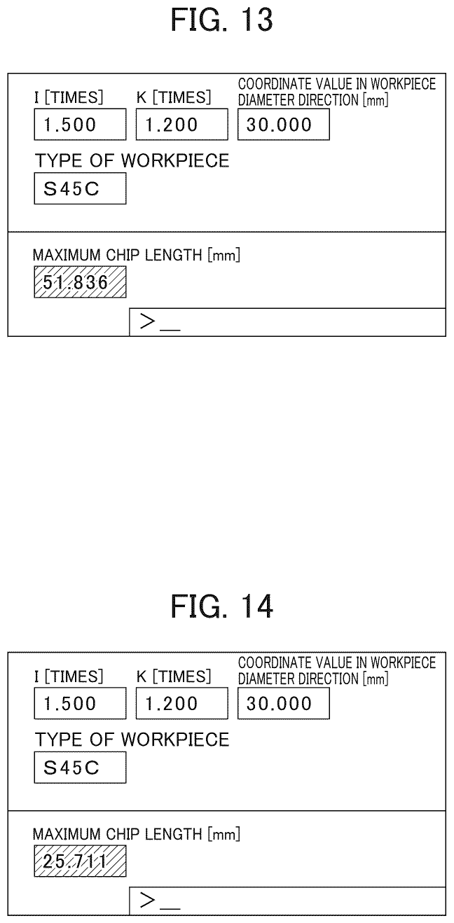

Next, a second example of the chip length correction method by the chip length calculation unit 13A will be described in detail with reference to FIGS. 11 to 14. FIGS. 11 and 12 are diagrams illustrating the second example of the chip length correction table. FIG. 13 is a diagram illustrating a chip length confirmation screen displaying the calculated chip length. FIG. 14 is a diagram illustrating a chip length confirmation screen displaying the chip length corrected for each type of workpiece.

First, the operator inputs the machining conditions including the coordinate value X in the workpiece diameter direction that is the information on the machining diameter, and the type (material) of workpiece, and the oscillation conditions including the oscillation frequency multiplying factor I and the oscillation amplitude multiplying factor K. Then, as illustrated in FIG. 13, the theoretical chip length automatically calculated by the chip length calculation unit 13A is displayed as the chip length on the chip length confirmation screen, corresponding to the selected type of workpiece. The operator operates the machine tool control device 1A before and after the above input operation, actually performs the oscillation cutting machining using the machining conditions and the oscillation conditions used for calculating the theoretical chip length, and measures the length of the obtained chips.

Next, the operator operates the input means of the input unit 11 to open the chip length correction table as illustrated in FIG. 11 to correct the calculated theoretical chip length. Then, as illustrated in FIG. 11, the chip length correction table automatically displays the coordinate value X in the workpiece diameter direction, the type of workpiece, the oscillation frequency multiplying factor I, and the oscillation amplitude multiplying factor K, which are input on the chip length confirmation screen, as well as the calculated theoretical chip length.

Then, the operator operates the input means of the input unit 11 to input the actual chip length measured. Based on the deviation multiplying factor between the theoretical chip length and the actual chip length, the correction value calculation unit 16 automatically calculates the correction coefficient. The calculated correction coefficient is automatically displayed in the chip length correction table. As illustrated in FIG. 14, the chip length displayed on the chip length confirmation screen is changed to the value of the chip length corrected using the correction coefficient.

As illustrated in FIGS. 11 and 12, the correction coefficient is calculated for each type of workpiece. In the second example, the correction coefficient is calculated for each type of workpiece, but the correction coefficient may also be calculated for each machining condition, including at least one of the material of the cutting edge of the cutting tool, the shape of the cutting edge of the cutting tool, the material of the workpiece, the cutting speed, the cutting depth, or the cutting angle. Similarly to the first example, if there are a plurality of combinations of machining conditions and oscillation conditions to be input, and there are a plurality of combinations of theoretical chip lengths and actual chip lengths for each combination of conditions, the correction value calculation unit 16 preferably automatically calculates the correction coefficient, based on the average value of the deviation multiplying factors between the theoretical chip length calculated for each combination and the actual chip length.

The machine tool control device 1A according to the second embodiment can achieve the following effects.

The machine tool control device 1A according to the second embodiment further includes the correction value calculation unit 16 that calculates the correction value used for correcting the chip length, in which the calculated chip length is corrected using the correction value calculated by the correction value calculation unit 16. More specifically, the actual chip length acquisition unit 17 that acquires the actual chip length obtained by performing the actual machining is further provided, in which the correction value is calculated based on the calculated theoretical chip length and the acquired actual chip length. This allows for calculating a more accurate chip length.

In the machine tool control device 1A according to the second embodiment, the correction value calculation unit 16 calculates the correction value for each machining condition. More specifically, the correction value calculation unit 16 calculates the correction value for each machining condition, including at least one of the material of the cutting edge of the cutting tool, the shape of the cutting edge of the cutting tool, the material of the workpiece, the cutting speed, the cutting depth, or the cutting angle. This allows for calculating an even more accurate chip length.

### Third Embodiment

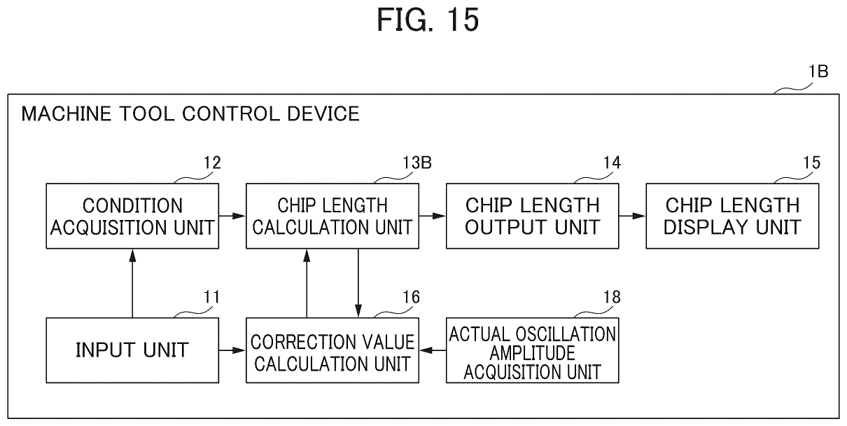

FIG. 15 is a functional block diagram of a machine tool control device 1B according to the third embodiment. As illustrated in FIG. 15, the machine tool control device 1B according to the third embodiment further includes a correction value calculation unit 16A and an actual oscillation amplitude acquisition unit 18, which differs from the machine tool control device 1 according to the first embodiment. Additionally, the chip length calculation unit 13B also performs chip length correction, which differs from the chip length calculation unit 13 of the first embodiment. Other configurations are common to the first embodiment.

The actual oscillation amplitude acquisition unit 18 acquires the actual oscillation amplitude of the cutting path measured by actually performing the oscillation cutting machining under the machining conditions and oscillation conditions used for calculating the theoretical chip length. The actual measured value of the cutting path can be acquired with a position detector, such as an encoder, usually provided in the servo motor. The acquired actual oscillation amplitude is output to the correction value calculation unit 16A, which will be described later.

The correction value calculation unit 16A calculates the correction value used for correcting the chip length. Specifically, the correction value calculation unit 16A calculates the correction value, based on the attenuation rate of the actual oscillation amplitude acquired by the actual oscillation amplitude acquisition unit 18, relative to the oscillation amplitude acquired by the condition acquisition unit 12, i.e., the command value of the oscillation amplitude. For example, the attenuation rate itself is used as the correction value. The calculated correction value is output to the chip length calculation unit 13B, which will be described later.

Similarly to the correction value calculation unit 16 of the second embodiment, the correction value calculation unit 16A preferably calculates the correction value for each machining condition, specifically including at least one of the material of the cutting edge of the cutting tool, the shape of the cutting edge of the cutting tool, the workpiece material, the cutting speed, the cutting depth, or the cutting angle.

The chip length calculation unit 13B calculates the theoretical chip length, based on the machining conditions and oscillation conditions acquired by the condition acquisition unit 12, using the same calculation method as the one used in the chip length calculation unit 13 of the first embodiment. When calculating the chip length using Formula 1 using the same calculation method as the one used in the chip length calculation unit 13 of the first embodiment, the chip length calculation unit 13B calculates the chip length by substituting the value obtained by multiplying the oscillation amplitude multiplying factor K by the attenuation rate as the correction value into Formula 1, instead of using the oscillation amplitude multiplying factor K. This allows for calculating the chip length corrected based on the attenuation rate.

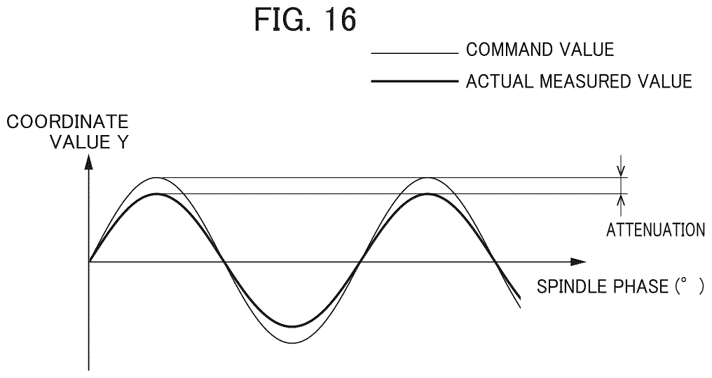

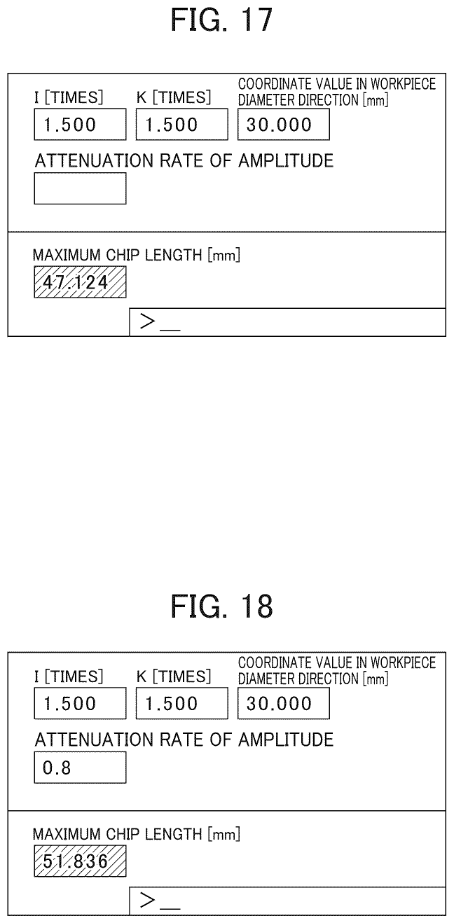

Next, the method of correcting the chip length by the chip length calculation unit 13B will be described in detail with reference to FIGS. 16 to 18. FIG. 16 is a diagram illustrating the attenuation rate of the actual measured value relative to the command value of the oscillation amplitude. FIG. 17 is a diagram illustrating a chip length confirmation screen where the attenuation rate of the oscillation amplitude has been input. FIG. 18 is a diagram illustrating a chip length confirmation screen displaying the chip length corrected based on the attenuation rate of the oscillation amplitude.

First, similarly to the first embodiment described above, the operator inputs the machining conditions including the coordinate value X in the workpiece diameter direction that is the information on the machining diameter, and the oscillation conditions including the oscillation frequency multiplying factor I and the oscillation amplitude multiplying factor K. Then, as illustrated in FIG. 17, the theoretical chip length automatically calculated by the chip length calculation unit 13B is displayed as the chip length on the chip length confirmation screen. The operator operates the machine tool control device 1A before and after the above input operation, actually performs the oscillation cutting machining using the machining conditions and the oscillation conditions used for calculating the theoretical chip length, and obtains the actual measured values of the cutting path.

Next, as illustrated in FIG. 16, the correction value calculation unit 16A calculates the attenuation rate of the actual measured value relative to the command value of the oscillation amplitude by comparing the command value and the actual measured value of the cutting path, and uses the calculated attenuation rate itself as the correction value. Then, the chip length calculation unit 13B calculates the chip length corrected based on the attenuation rate, and as illustrated in FIG. 18, the chip length confirmation screen displays the attenuation rate of the oscillation amplitude, in which the chip length displayed is changed to the chip length corrected based on the attenuation rate.

The machine tool control device 1B according to the third embodiment can achieve the following effects.

The machine tool control device 1B according to the third embodiment further includes the actual oscillation amplitude acquisition unit 18 that acquires the actual oscillation amplitude obtained by actually performing the oscillation cutting machining, in which the correction value calculation unit 16A calculates the correction value, based on the attenuation rate of the actual oscillation amplitude acquired by the actual oscillation amplitude acquisition unit 18, relative to the oscillation amplitude acquired by the condition acquisition unit 12. This allows for calculating a more accurate chip length.

The present disclosure is not limited to the above embodiments, and modifications and improvements that can achieve the object of the present disclosure are included in the present disclosure.

For example, in the second and third embodiments described above, the correction value calculation unit 16, 16A automatically calculates the correction value, but this is not limiting. The operator may manually input and set the correction values obtained by calculation on an external computer, etc.

For example, in the third embodiment described above, if the attenuation rate of the actual oscillation amplitude can be determined from the frequency response of the machine, the correction value may be calculated based on that attenuation rate.

### EXPLANATION OF REFERENCE NUMERALS

1, 1A, 1B: machine tool control device
11: input unit
12: condition acquisition unit
13, 13A, 13B: chip length calculation unit
14: chip length output unit
15: chip length display unit
16, 16A: correction value calculation unit
17: actual chip length acquisition unit
18: actual oscillation amplitude acquisition unit

1. A control device for a machine tool that machines a workpiece by relatively oscillating a cutting tool and the workpiece, the control device comprising:
a condition acquisition unit that acquires a machining condition and an oscillation condition;
a chip length calculation unit that calculates a chip length, based on the machining condition and the oscillation condition acquired by the condition acquisition unit; and
a chip length output unit that outputs the chip length calculated by the chip length calculation unit.

2. The control device for a machine tool according to claim 1, further comprising a chip length display unit that displays the chip length output by the chip length output unit.

3. The control device for a machine tool according to claim 1, wherein the condition acquisition unit acquires
the machining condition including information on a machining diameter, and
the oscillation condition including information on a number of oscillations per relative revolution of the cutting tool and the workpiece, and information on oscillation amplitude relative to a feed amount per relative revolution of the cutting tool and the workpiece.

4. The control device for a machine tool according to claim 1, further comprising a correction value calculation unit that calculates a correction value used for correcting the chip length, wherein
the chip length calculation unit corrects the chip length calculated based on the machining condition and the oscillation condition acquired by the condition acquisition unit, using the correction value calculated by the correction value calculation unit.

5. The control device for a machine tool according to claim 4, further comprising an actual chip length acquisition unit that acquires an actual chip length obtained by actually performing the machining, wherein
the correction value calculation unit calculates the correction value, based on the chip length calculated by the chip length calculation unit and the actual chip length acquired by the actual chip length acquisition unit.

6. The control device for a machine tool according to claim 4, wherein the correction value calculation unit calculates the correction value, based on an attenuation rate of actual oscillation amplitude relative to oscillation amplitude.

7. The control device for a machine tool according to claim 6, further comprising an actual oscillation amplitude acquisition unit that acquires actual oscillation amplitude obtained by actually performing the machining, wherein
the condition acquisition unit acquires the oscillation amplitude, and
the attenuation rate of the actual oscillation amplitude relative to the oscillation amplitude is calculated based on the oscillation amplitude acquired by the condition acquisition unit and the actual oscillation amplitude acquired by the actual oscillation amplitude acquisition unit.

8. The control device for a machine tool according to claim 4, wherein the correction value calculation unit calculates the correction value for each machining condition.

9. The control device for a machine tool according to claim 8, wherein the correction value calculation unit calculates the correction value for each machining condition, including at least one of a material of a cutting edge of the cutting tool, a shape of the cutting edge of the cutting tool, a material of the workpiece, a cutting speed, a cutting depth, or a cutting angle.
